(19) United States
(12) Patent Application Publication
(10) Pub. No.: US 2016/0188068 A1
(43) Pub. Date: Jun. 30, 2016

(54) TACTILE INTERFACE FOR A COMPUTING DEVICE

(71) Applicant: Tactus Technology, Inc., Fremont, CA (US)

(72) Inventors: Micah Yairi, Fremont, CA (US); Craig Ciesla, Fremont, CA (US); Curtis Ray, Fremont, CA (US); Radhakrishnan Parthasarathy, Fremont, CA (US); William Tulay Stacy, Fremont, CA (US)

(21) Appl. No.: 14/821,526

(22) Filed: Aug. 7, 2015

Related U.S. Application Data
(60) Provisional application No. 62/034,717, filed on Aug. 7, 2014.

(51) Int. Cl. G06F 3/041; G06F 3/045; G06F 3/01; G06F 3/044

(52) U.S. Cl. CPC G06F 3/0414; G06F 3/0416; G06F 3/044; G06F 3/045; G06F 3/016; G06F 2203/04102; G06F 2203/04105

(57) ABSTRACT

Input is detected on a dynamic tactile interface based on pressure events and touch sensor outputs. The dynamic tactile interface includes a touch sensor, a pressure sensor, and a compressible material. When both a pressure event and touch sensor output are correlated to identify an input, the input is processed by a display device associated with the dynamic tactile interface. The flexible material may be implemented as a variable volume associated with a deformable region, such that when the deformable region is depressed the variable volume decreases and the pressure sensor detects increased pressure. The flexible material may be implemented as a compressible layer between two layers that comprise the touch sensor, such that when an input is received on an upper layer of the touch sensor, the middle layer having the flexible volume may compress. The multi-layer touch sensor can be a capacitance touch or resistive touch sensor.

### CROSS-REFERENCE TO RELATED APPLICATIONS

This application claims the benefit of U.S. Provisional Application No. 62/034,717, filed on 7 Aug. 2014, which is incorporated in its entirety by this reference.

This application is related to U.S. patent application Ser. No. 12/319,334, filed on 5 Jan. 2009; U.S. patent application Ser. No. 12/497,622, filed on 21 Oct. 2009; U.S. Pat. No. 8,922,502, filed on 21 Dec. 2010, U.S. patent application Ser. No. 14/317,685, filed on 27 Jun. 2014, and U.S. patent application Ser. No. 12/652,708, filed on 5 Jan. 2010, all of which are incorporated in their entireties by this reference.

### TECHNICAL FIELD

This invention relates generally to the field of touch-sensitive interfaces, and more specifically to a touch-sensitive layer for a computing device.

### BRIEF DESCRIPTION OF THE FIGURES

FIG. 1 is a flowchart representation of a method S100 of the invention;

FIG. 2 is a schematic representation of variations of the method; and

FIG. 3 is a flowchart representation of one variation of the method.

FIG. 4 is a schematic representation of one variation of a touch-sensitive interface.

FIG. 5 is a schematic representation of one variation of a touch-sensitive interface.

FIG. 6 is a schematic representation of one variation of a touch-sensitive interface.

FIG. 7 is a schematic representation of one variation of a touch-sensitive interface.

### DESCRIPTION OF THE EMBODIMENTS

The following description of the preferred embodiment of the invention is not intended to limit the invention to these preferred embodiments, but rather to enable any person skilled in the art to make and use this invention.

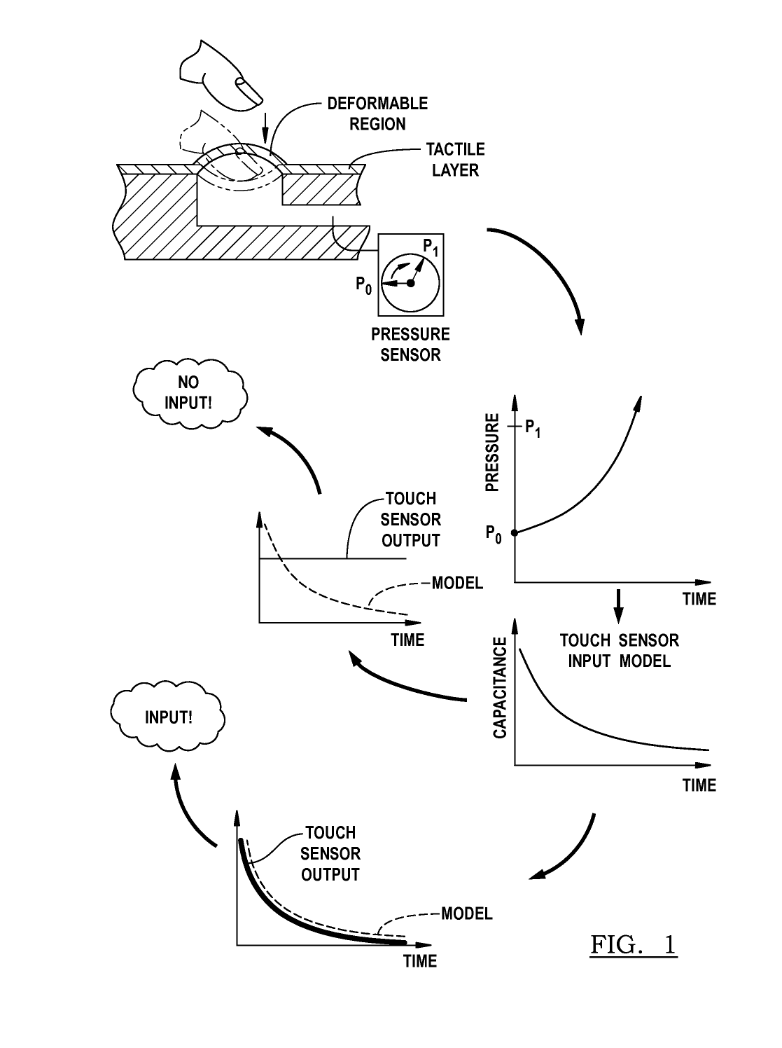

As shown in FIG. 1, a method S100 functions to detect an input on a dynamic tactile interface. The dynamic tactile interface includes a tactile layer and a substrate, the tactile layer defining a tactile surface, a deformable region, and a first region adjacent the deformable region and coupled to the substrate opposite the tactile surface, the deformable region cooperating with the substrate to form a variable volume fluidly coupled to a fluid channel, the deformable region in an expanded setting tactilely distinguishable from the first region, the fluid channel fluidly coupled to a pressure sensor, and the substrate coupled to a touch sensor. The method includes: at the pressure sensor, detecting a pressure-related event and a time of the pressure-related event, the pressure-related event corresponding to depression of the deformable region from the expanded setting; transforming the pressure-related event into a touch sensor input model associated with the time; and identifying an input on the tactile surface at a region corresponding to the deformable region based on correlation between the touch sensor input model and an output of the touch sensor within a threshold period of the time.

1. Applications

Generally, method S100 functions to identify an input on the tactile surface by correlating the touch sensor input model, derived from data collected from the pressure-related event and the time of the pressure-related event, with the output of the touch sensor.

Method S100 can function to lessen sampling duration of the touch sensor by identifying, from the pressure-related event, an appropriate period over which the touch sensor can sample in order to detect an input on a tactile surface. The appropriate period can correspond to the time of the pressure-related event. Thus, method S100 can reduce time over which a touch sensor is enabled (e.g., “on”), thereby reducing battery usage and increasing efficiency of the device. For example, method S100 can be implemented by a device with a capacitive touch sensor and a gauge pressure sensor that detects the gauge pressure of fluid within the variable volume of fluid. With the gauge pressure sensor, method S100 can detect a change in pressure within the variable volume of fluid over a corresponding period of time. In response to the change in pressure, method S100 can generate a touch sensor input model over the corresponding period of time. The touch sensor input model predicts touch sensor outputs that correspond to the change in pressure within the variable volume resulting from the pressure-related event (e.g., depression of the deformable region). Method S100 can, thus, compare the touch sensor input model to touch sensor outputs over the corresponding period of time. At times outside the corresponding period of time, the touch sensor can be disabled as no pressure-related event occurs and, thus, no input to the tactile layer is detectable by the touch sensor outside the corresponding period of time. Likewise, method S100 can lessen sampling duration of the pressure sensor by identifying, from a touch-related event, an appropriate period over which the pressure sensor is sampled in order to detect a pressure-related event.

Method S100 can also reduce sampling rates by identifying, from the pressure-related event and the time of the pressure-related event, appropriate intervals at which to sample the touch sensor in order to detect an input on the tactile layer. For example, method S100 can be implemented by a device with a capacitive touch sensor and a strain gauge coupled to the tactile layer. Method S100 can detect a pressure-related event corresponding to a change in strain of the deformable region due to deformation of the deformable region.

Method S100 can additionally or alternatively confirm an intentional input to the tactile interface and, likewise, distinguish between intentional and incidental inputs. Method S100 can identify an input by comparing the touch sensor input model to the touch sensor output. In response to correlation, similarities, and/or a match between the touch sensor input model and the touch sensor output within a period of time, method S100 can identify the pressure-related event as confirmation that the touch sensor output corresponds to an intentional input.

Method S100 can identify the magnitude, velocity, acceleration, location, and/or duration, etc. of an input on a touch sensor. Method S100 can manipulate data from the pressure-related event (e.g., change in pressure) to calculate a force applied to the deformable region during an input, velocity of the input, and/or acceleration of the input. Method S100 can determine how rapidly a window rendered on the device scrolls down based on the velocity and/or acceleration of the input. For example, method S100 can increase the rate at which the window scrolls in response to a higher velocity input to the tactile interface. Method S100 can also manipulate a shutter speed and/or an exposure time of a camera application executing on the device based on the velocity of the input. For example, method S100 can increase shutter speed in response to a higher velocity input and increase exposure time in response to a lower velocity input. Likewise, method S100 can manipulate the volume of an audio output of the device based on to the force of the input to the tactile interface. For example, if the force of the input exceeds a threshold force, method S100 can mute the volume output by the device.

2. Hardware

The dynamic tactile interface can include and/or interface with a dynamic tactile layer including a substrate, the dynamic tactile layer including a deformable region and a peripheral region adjacent the deformable region and coupled to the substrate opposite the dynamic tactile layer, and the deformable region cooperating with the substrate to form a variable volume filled with a mass of fluid. Generally, the dynamic tactile layer defines one or more deformable regions operable between expanded and retracted settings to intermittently define tactilely distinguishable formations over a surface, such as over a touch-sensitive digital display (e.g., a touchscreen), such as described in U.S. patent application Ser. No. 13/414,589.

3. Method

Generally, Block S110 of method S100 includes, at the pressure sensor, detecting a pressure-related event and a time of the pressure-related event, the pressure-related event corresponding to deformation of the deformable region.

Method S100 can be implemented on a computing (e.g., electronic) device that also includes a digital display coupled to a substrate opposite a tactile layer and can interface with a displacement device to displace fluid from a reservoir into a variable volume filled with a mass of fluid, thereby transitioning a deformable region, which partially defines the variable volume, into an expanded setting and raising the tactile surface at the deformable region above the tactile surface at the peripheral region such that the deformable region is tactilely distinguishable from the peripheral region. Method S100 can alternatively interface with a dynamic tactile interface in which the deformable region in the expanded setting is flush with the peripheral region or below the peripheral region. However, in the expanded setting, the deformable region can define any other formation that is capable of being deformed or depressed by an input object.

The dynamic tactile interface detects contacts by an object on the tactile surface of the tactile layer of the dynamic tactile interface. The tactile layer includes a tactile surface opposite an attachment surface and a deformable region. The tactile layer can be substantially transparent or translucent. In a variation in which an object is detected to make contact with a dynamic tactile interface coupled to an electronic device without a digital display, the tactile layer can be opaque. The tactile layer can be attached to a substrate via an attachment face opposite the tactile surface of the tactile layer. The tactile layer can include one or more peripheral regions and one or more deformable regions. In one implementation, a deformable region is adjacent the peripheral region, wherein a portion of the peripheral region includes an active sensing area. In a variation in which the dynamic tactile interface lies over a digital display, an object can be detected when it makes contact with the active sensing area residing substantially over an image of an input key or substantially adjacent an area directly over the image of the input key.

The active sensing area can be of any shape or size and can correspond to a touch sensor, such as a capacitive touch sensor, resistive touch sensor, optical touch sensor, and/or other sensor configured to detect contact at one or more points or areas on the computing device. Additionally or alternatively, a contact can be detected upon making contact with the tactile surface with any other suitable type of sensor or input region configured to capture an input on a surface of the device. The device can also incorporate an optical sensor (e.g., a camera), a pressure sensor, a temperature sensor (e.g., a thermistor), or other suitable type of sensor to capture an image (e.g., a digital photographic image) of the input object (e.g., a stylus, a finger, a face, lips, a hand etc.), a force and/or breadth of an input, a temperature of the input, etc., respectfully.

Block S110 can detect a pressure of the variable volume with a pressure sensor, such as a gauge, absolute, capacitive, thin film, or other pressure sensor. Additionally or alternatively, Block S110 can detect a strain of the deformable region with a strain gauge (e.g. a piezoresistive strain gauge) and can correlate the strain with the pressure of the variable volume. The pressure sensor can continuously, intermittently, or instantaneously sample the pressure sensor for the pressure of the variable volume. Block S110 can sample the pressure instantaneously when the pressure exceeds a predetermined threshold pressure. Block S110 can also sample multiple pressures over time and record a time of each pressure measurement. For example, Block S110 can continuously record pressure measurements following a detected pressure at or above a threshold pressure. Block S110 can continue to record pressure measurements while the pressure remains above the threshold pressure or within a predetermined range of pressures. Alternatively, Block S110 can sample pressures within the variable volume continuously, such as at a static or dynamic sampling rate. For example, the sampling rate of the pressure sensor can be higher than a sampling rate of the touch sensor to reduce computational and energetic expense. For example, Block S110 can detect the pressure of the variable volume with a single pressure sensor. In contrast, the touch sensor can include many capacitors, which can be sampled to detect a touch. Thus, Block S110 can sample the pressure sensor at a faster sampling rate than the touch sensor as the pressure sensor includes fewer elements to sample from than the touch sensor. Furthermore, the touch sensor charges each capacitor to a voltage in order to detect capacitance of the tactile interface. In order to charge each capacitor, the touch sensor draws energy from an energy source (e.g., a battery). Thus, the touch sensor draws more energy to charge each capacitor than the energy required to drive the pressure sensor. Accordingly, Block S110 can function to reduce energy consumption and computational expense by disabling the touch sensor until the pressure sensor detects the pressure-related event. Block S110 can detect pressure-related events including increases, decreases, or no changes in pressure over time. Block S110 can additionally or alternatively detect a force, velocity, and/or acceleration of an input on the device that deforms the deformable region.

Generally, Block S120 of method S100 includes transforming the pressure-related event into a touch sensor input model associated with the time. Method S100 functions to generate a predictive model of the output of the touch sensor or a touch event that corresponds to the pressure-related event using pressure-related event data (e.g., pressure values). Block S120 can associate the pressure-related event with the time of the pressure-related event by timestamping pressure data. For example, Block S120 can timestamp a pressure that exceeds the predetermined threshold pressure with the time that the pressure exceeded the predetermined threshold pressure. Thus, Block S120 can model a time corresponding to a touch sensor output. A processor within the device can also execute Block S120 to transform pressure data, received from the pressure sensor in Block S110, into data curves (or a numerical dataset of the same). For example, pressure, velocity, acceleration, force, and time data collected by Block S110, can be transformed into data curves. Block S120 can also use preexisting data to transform the pressure-related event into a model that predicts a touch event. For example, Block S120 can use time-displacement numerical data to transform displacement data of the displacement of the deformable region to a model predicting capacitance detected by the touch sensor. Likewise, Block S120 can manipulate the pressure-related event data with preexisting pressure-capacitance data to predict local changes in capacitive decay at a touch sensor resulting from the input. Block S120 can selectively transform any portion or all of the pressure-related event data detected in Block S110 into the touch sensor input model.

Generally, Block S130 of method S100 includes identifying an input on the tactile surface at a region corresponding to the deformable region based on correlation between the touch sensor input model (generated in Block S110) and an output of the touch sensor within a threshold period of the time. In particular, Block S130 can identify a touch event (e.g., an input to the tactile interface) in response to similarity, consistency, correlation, and/or an approximate match between the touch sensor input model and the output of the touch sensor.

Block S130 can sample the touch sensor (e.g., a capacitive, resistive, optical, and/or any other suitable touch sensor) a sampling rate. Block S130 can sample the touch sensor continuously (e.g., at a sampling rate of 30 Hz) or intermittently and can store touch sensor outputs indefinitely or for a limited period of time (e.g., ˜99 ms, or three sample periods). In particular, Block S130 can sample the touch sensor continuously and store all outputs of the touch sensor. Thus, Block S130 can compare all outputs of the touch sensor with the touch sensor input model to identify the input corresponding to any of the outputs of the touch sensor. Additionally, Block S110 can detect a delay between the time of the pressure-related event (e.g., depression of the deformable region) and a time the pressure sensor detects the change in pressure in the variable volume due to the pressure-related event. Block S130 can predict the delay and compare touch sensor outputs substantially at the time of the pressure-related event rather than at the time the pressure sensor detects the change in pressure. Thus, Block S130 can remove the delay. Likewise, Block S110 can predict the delay prior to timestamping the pressure-related event data and, thus, remove the delay prior to transforming the data to a model in Block S120. Alternatively, Block S130 can store outputs of the touch sensor for a predetermined interval (e.g., 1 second). Thus, Block S130 can compare outputs of the touch sensor from the predetermined interval (e.g., back up to 1 second) with the touch sensor input model to identify the input within the predetermined interval. Block S130 can also store outputs of the touch sensor in response to the pressure-related event. For example, Block S110 can detect a pressure-related event, wherein the pressure exceeds a threshold pressure at a time. Thus, Block S130 can store outputs of the touch sensor for a period of time following the time of the pressure-related event. Block S130 can sample outputs of the touch sensor at a sampling rate faster than, slower than, or substantially similar to the sampling rate of the pressure sensor.

### 4. EXAMPLES

Generally, method S100 functions to detect and transform the pressure-related event and the time of the pressure-related event to the touch sensor input model and can identify an input from correlation between the touch sensor input model and the output of the touch sensor.

4.1 Threshold Pressure

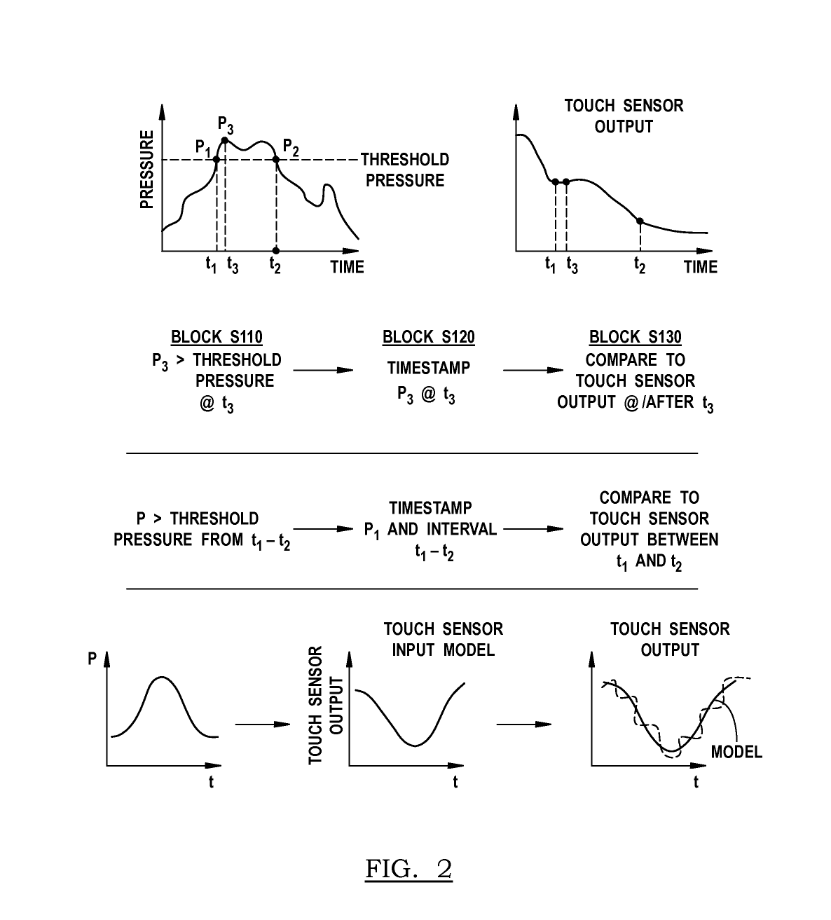

In one example shown in FIG. 2, method S100 can identify an input to the tactile interface in response to detection of a pressure-related event characterized by an increase in fluid pressure within the variable volume that exceeds a threshold pressure. Method S100 can detect a pressure of the variable volume greater than the threshold pressure and a corresponding time of the pressure change event. Thus, method S100 can identify the output of the touch sensor at the corresponding time of the pressure as an input by triggering the touch sensor to search for the location of the input that mimic the change in pressure and occurs within a threshold time of the pressure-related event.

In particular, Block S110 of method S100 detects a pressure-related event corresponding to deformation of the deformable region and records data output by a pressure sensor, such as a change in pressure of the variable volume, an absolute pressure and/or a change in strain of the deformable region of depression of the deformable region, etc. Block S110 can continuously or intermittently sample for pressure, velocity, acceleration, strain, etc. If the pressure-related event yields a detected pressure greater than a predetermined threshold pressure, Block S110 can record the pressure-related event and the time of the pressure-related event. Block S110 can alternatively detect pressures within a range of threshold pressures (e.g., 1-2 atm). If Block S110 detects a pressure within the range of threshold pressures, Block S110 can record the pressure and a time the pressure occurred. Alternatively, Block S110 can detect and record pressures outside the range of threshold pressures. Block S110 can also detect and record pressures below a minimum pressure.

Block S120 of method S100 can transform the pressure and the time the threshold pressure occurred to a touch sensor input model. Block S120 can model a time or interval of time at which a change in the output of the touch sensor can occur. The time can correspond to the time the threshold pressure occurred. Thus, Block S120 can transform the pressure-related event to the time or the time interval over which the touch sensor can detect a touch event. Block S120 can, thus, function to trigger the touch sensor to output touch sensor data (e.g., capacitive decay).

In this example, Block S130 of method S100 can identify the input in response to a threshold output or change in output of the touch sensor substantially at the time the threshold pressure occurred or within the time interval. For example, Block S130 can detect a change in capacitance of the tactile layer at a time substantially corresponding to the time the threshold pressure occurred and match the output from the touch sensor with the pressure-related event. Thus, Block S130 can interpret the change in capacitance as an input.

In one example, an input to the tactile interface can be detected in response to detection of a touch related event characterized by a signal output by a touch sensor. When the touch sensor provides an output, a determination may be made as to whether a pressure-related event corresponding to deformation of the deformable region is also detected at the particular deformable region associated with the location of the touch sensor. The touch sensors may be continuously on, intermittently on, or on for some other period of time to detect a touch received at that particular sensor. Pressure sensors may be kept off until a corresponding touch sensor detects a touch. At that point, the touch sensors may continuously sample for pressure, velocity, acceleration, strain, etc. The pressure-related event yields a detected pressure, for example a pressure that is greater than a threshold pressure. A pressure-related event and time of the pressure-related event can be recorded. Based on the touch sensor output and the pressure-related event and time of the pressure-related event, the input may be identified as intended user input or an unintended input. If the input is identified as an unintended input, no action is taken. If the input is identified as an unintended input, the input associated with the deformable region and corresponding pressure event is processed based on, for example, a rendered interface provided by the device on which the pressure sensor and touch sensors are implemented.

In an example, an input may be detected based on multiple touch sensors and multiple pressure events. Some inputs for display device may require multiple points of input. For example, the zoom input may require selection of a zoom button and an indication of which way to zero, for example a “+” button for zooming in and day “−” button for zooming out. The input to the tactile interface can be detected in response to detecting pressure events associated with different deformable regions and can occur at simultaneous points in time. For example, a pressure event may be detected at a first deformable region associated with a first key on a rendered keyboard provided within a display and a second pressure event may be detected at a second deformable region associated with a second key on the rendered keyboard provided within the display. Based on the two pressure events, touch sensors may perform sampling at surface of the touch sensor for a touch input. Particularly, a first touch sensor at the first deformable region made be sampled at the pressure event time associated with the pressure event and a second touch sensor at the second deformable region may be sampled at the second pressure event time associated with the second pressure event. If an input is identified from the first pressure event and first sensor input and a second input is identified from the second pressure event in the second sensor input the two inputs are provided to the display to achieve a task associated with the two points of input. In some implementations, the force, velocity, and other pressure event data measured by the pressure sensors may provide varying input to the display device. For example, a pressure sensor for a first deformable region may identify an input that depresses and holds the deformable region and a depressed state while a pressure sensor at a second deformable region detects that the deformable region is repeatedly depressed and released multiple times. In the example of the zoom input, this would result in repeatedly increasing or decreasing the zoom as the second deformable region is repeatedly depressed.

4.2 Threshold Pressure Differential

In another example shown in FIG. 2, method S100 can identify an input to the tactile interface in response to correlation between the touch sensor input model, derived from detected pressures sampled over a time period and within a pressure range, and the touch sensor output.

In this example, Block S110 of method S100 can record two or more pressure measurements within a time interval and a time corresponding to one or both pressure measurements within the time interval. For example, Block S110 can detect a first pressure at a first time and a second pressure at a second time. Alternatively, Block S110 can sample pressures from the pressure sensor continuously and store only the first pressure and the second pressure. For example, Block S110 can selectively store pressures that exceed a threshold pressure and omit pressures below the threshold pressure. The first time and the second time can define a time interval over which all pressures exceed a threshold pressure or fall within a pressure range. Outside of the time period (e.g. before the first time and after the second time), Block S110 detects pressures below the threshold pressure or outside of the pressure range. In another implementation, Block S110 can detect the first pressure at the first time, the first pressure exceeding the threshold pressure. A predetermined time later (e.g. the second time), Block S110 can detect the second pressure. In yet another implementation, Block S110 can detect the first pressure at the first time and the second pressure at a second time, the second pressure a predetermined pressure greater than or less than the first pressure. For example, Block S110 can detect and record the first pressure (e.g., 1 atm.) and sample continuously until a change in pressure greater than a predetermined pressure change above the first pressure is detected (e.g. 2 atm). When Block S110 detects a pressure greater than the predetermined pressure change, Block S110 detects and stores the second pressure and the second time (e.g., 3 atm).

Block S120 of method S100 can model the pressure measurements of Block S110 and the time corresponding to each pressure measurement as a pressure versus time curve (or a numerical model exhibiting the same). Block S120 can model an interval over which the pressure-related event occurred (e.g., depression of the deformable region) and, thus, a corresponding time interval over which the input on the tactile interface is likely to be detected by the touch sensor. Block S120 can also couple preexisting data (e.g. data correlating a magnitude of pressure or change in pressure detected by the pressure sensor to capacitance, resistance, or other output of the touch sensor) to pressure measurements detected by Block S110. Thus, Block S120 can transform pressure measurements into predicted outputs of the touch sensor. For example, Block S120 can model predicted change in capacitance over a time interval, wherein a first capacitance at the first time corresponds to the first pressure at the first time and a second capacitance at the second time corresponds to the second pressure at the second time.

Block S130 can identify the input to the tactile interface by detecting a change in the output of the touch sensor (e.g., capacitance) within the corresponding time interval. Additionally or alternatively, Block S130 can identify the input by detecting a pattern of the output of the touch sensor over the time interval (e.g., capacitance over time) that correlates to, corresponds to, or substantially matches the model of predicted change in capacitance over the time interval generated in Block S120. Furthermore, Block S130 can identify the input by detecting a change in output of the touch sensor (e.g., a change in capacitance) of a magnitude greater than or equal two the predicted change in capacitance of Block S120 across any time interval.

4.3 Pressure Curve

In another example shown in FIG. 2, method S100 identifies an input to the tactile interface in response to correlation between the touch sensor input model derived from detected pressures sampled over a period of time and the output from the touch sensor. In particular, method S100 identifies the input in response to a substantial match or correlation between numerical data correlating multiple pressures and time detected by the pressure sensor over a time interval and numerical data representing outputs of the touch sensor (e.g., capacitance) over the same time interval.

In particular, Block S110 can sample and store a set of pressures detected by the pressure sensor. For example, Block S110 can selectively sample and store pressures following an event that yields a pressure that exceeds the predetermined threshold pressure or corresponds to a predetermined pattern of pressures over time (e.g., a sharp increase in pressure within 1 millisecond). Block S110 can sample pressures for a specified interval following the event. Alternatively Block S110 can sample pressures until Block S110 detects a pressure below a minimum pressure or a second event occurs (e.g., a sharp decrease in pressure). Block S110 further detects times associated with each pressure in the set of pressures.

Block S120 can model the set of pressures over time, thereby yielding a pressure versus time curve. Block 120 can characterize pressure-time data and, thus, model inflection points, peaks, troughs, minima, maxima, etc. of the pressure-time data and interpret the characterized data to model the touch sensor input model. Block S120 can predict capacitive decay curves corresponding to capacitive decay of a capacitive touch sensor and a proximal capacitive entity (e.g., a user or stylus). For example, Block S120 can model several maxima in pressure over a given time period. Thus, Block S120 can transform the maxima into a model of a pulsating input (e.g. a user touching the tactile interface and lifting off repeatedly). Block S120 can further model contours of pressure-time data to predict acceleration, velocity, and/or force of the deformation of the deformable region and, thus, of the input by the user.

Block S130 can identify the input based on correlation between the touch sensor output model of Block S120 and the output from the touch sensor detected at a time interval substantially corresponding to the time interval of the touch sensor output model. In particular, Block S130 can compare the touch sensor input model of Block S120 with the output from the touch sensor. If the output from the touch sensor substantially matches or correlates to the touch sensor input model, Block S130 can identify the output from the touch sensor as corresponding to an input. Block S130 can define sampling rates of the touch sensor using the touch sensor input model. For example, for a touch sensor input model with semi-periodic multiple minima and maxima and an effective period, Block S130 can define a sampling rate faster than the effective period in order to capture minima and maxima of the output of the touch sensor. Block S130 can increase the sampling rate of the touch sensor based on irregularities in the touch sensor input model (e.g., nonlinear capacitance versus time curves) and decrease the sampling rate of the touch sensor based on predictable patterns in the touch sensor input model (e.g., exponential decay of capacitance versus time). Block S130 can also indicate to the touch sensor to retrieve touch sensor outputs for a specified interval prior to the time of the pressure-related event in order to overcome processing delays during Blocks S120 and S130.

4.4 Displacement Curve

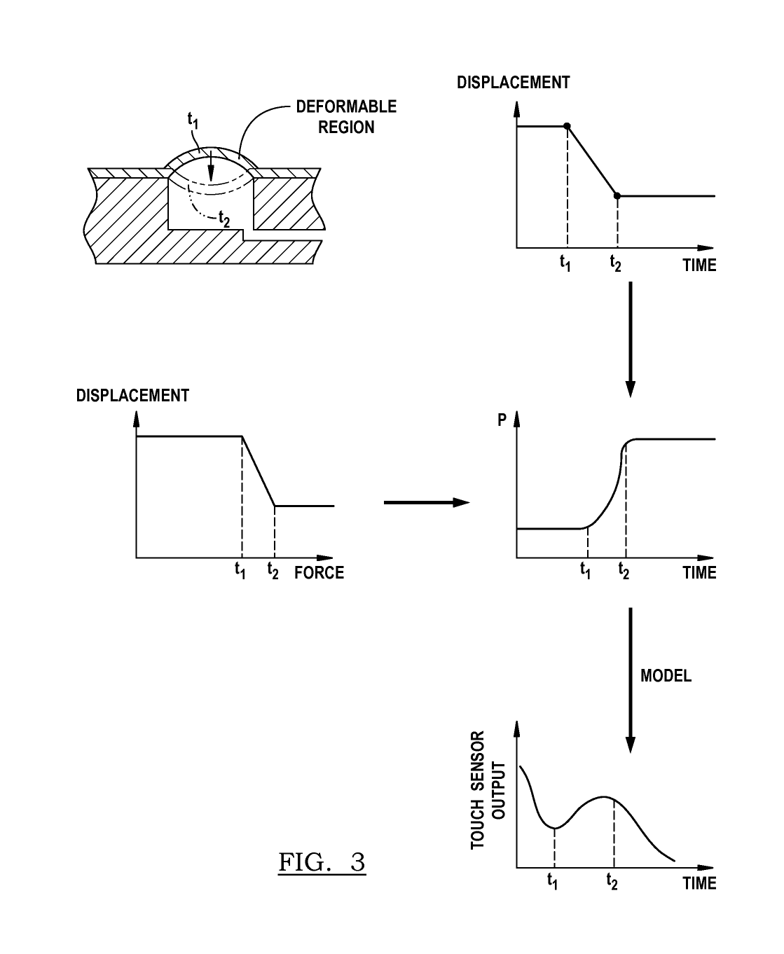

In another example shown in FIG. 3, method S100 identifies an input to the tactile interface based on correlation between a force-displacement model (and/or a time-displacement model) of a deformable region and the touch sensor output. In particular, method S100 can be implemented with a tactile including a “snap dome” deformable region, as described in U.S. patent application Ser. No. 12/652,708, which is incorporated herein in its entirety by this reference. The “snap dome” deformable region substantially resists deformation up to a threshold pressure applied to the deformable region. When the pressure applied to the deformable exceeds the threshold pressure, the “snap dome” deformable region collapses and deforms into a retracted setting substantially flush or below the peripheral region.

Block S110 can detect a pressure-related event corresponding to deformation of a deformable region at the time corresponding to the collapse of the “snap dome” deformable region into the retracted setting. Block S110 can detect a pressure change at the pressure sensor. Alternatively, Block S120 can model and/or draw on preexisting models representing the force required to displace the “snap dome” deformable region. Block S120 can implement a pre-existing force-displacement model, pressure-displacement model, and/or time-displacement model to model the pressure change of the variable volume adjacent the “snap dome.” Block S120 can transform the pressure change model into a touch sensor input model. Block S130 can compare the touch sensor input model with the output of the touch sensor to verify and identify an input to the tactile interface. Additionally, Block S130 can indicate to the touch sensor to sample at a higher rate across the time interval corresponding to displacement of the “snap dome”

4.5 Touch-Driven Model

One variation of method S100 includes detecting a touch-related event at a touch-sensor and a time of the touch-related event; transforming the touch-related event and the time into a model of predicted pressure sensor data; and detecting an input on the tactile surface based on similarities between the model and real pressure-sensor data.

Block S110 can additionally or alternatively detect a touch-related event at the touch sensor. For example, Block S110 can change in capacitance at a capacitive touch sensor over a time interval. In response to a detected touch-related event, Block S120 can transform the change in capacitance (or the change in capacitive decay over the time interval) into a model predicting pressure sensor outputs. For example, Block S120 can predict a magnitude of pressure change over the time interval. Block S130 can correlate the model with a real pressure sensor output. In response to a substantial match or correlation between the model and the real pressure sensor output across a portion or the whole of the time interval, Block S130 can identify a pressure-related input (e.g., depression of a deformable region). The variation can function to reduce computational expense and runtime of handling outputs of the pressure sensor. Thus, by detecting a touch-related event in Block S110, Blocks S120 and S130 can enable the pressure sensor to detect and/or store pressure values. The variation can further function to verify a touch-related event (e.g., contact with a tactile interface) with a subsequent pressure-related event. Block S130 can also define a sampling rate of the pressure that is faster than a capacitive decay timing of the touch sensor.

As a person skilled in the art will recognize from the previous detailed description and from the figures and claims, modifications and changes can be made to the preferred embodiments of the invention without departing from the scope of this invention as defined in the following claims.

In some implementations, the touch sensor can be implemented using a single upper layer. In this implementation, when the single upper layer is deformed, for example due to force exerted by a user's finger, a stylus, or other device, the deformation of the upper layer may create a signal that indicates the presence of a touch event and the location of the touch event.

In some implementations, the touch sensor can be implemented using an upper layer positioned above the middle layer and a lower layer positioned below the middle layer. In this implementation, when the single upper layer is deformed through the middle layer and towards the lower layer, for example due to force exerted by a user's finger or a stylus, the deformation of the upper layer coming in close proximity to the lower layer, or in contact with the lower layer, may create a signal that indicates the presence of a touch event and the location of the touch event.

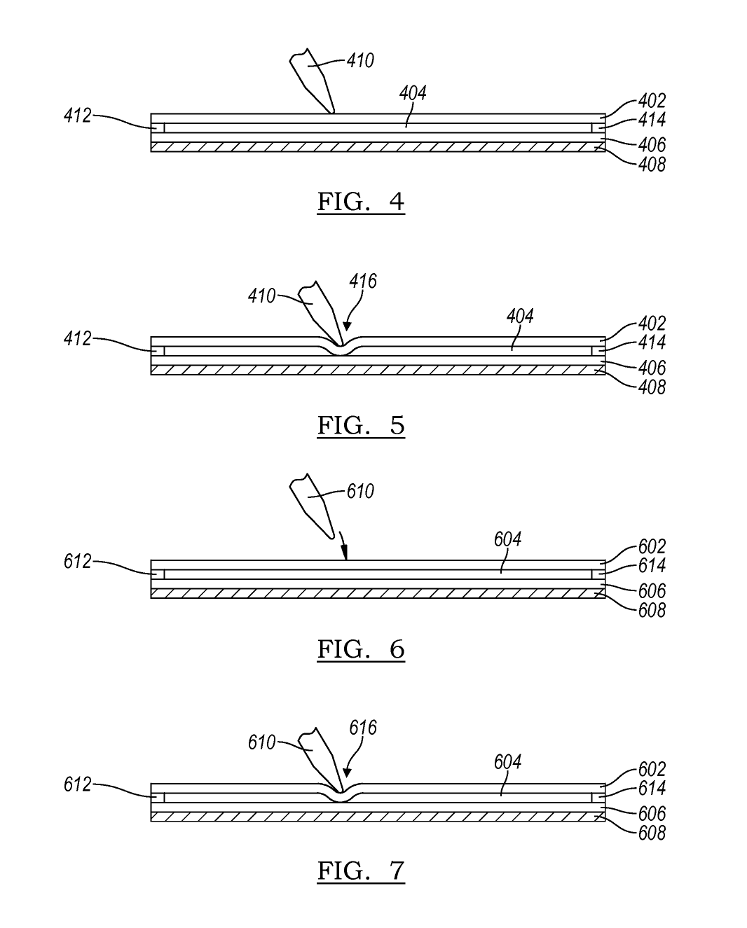

FIG. 4 is a schematic representation of one variation of a touch-sensitive interface. The touch sensitive interface of FIG. 4 includes an upper touch sensor layer 402, a lower touch sensor layer 406, and a middle layer 404. Upper layer 404 may form part of a touch sensor in conjunction with lower layer ₄06. The touch sensor may be a capacitive touch sensor, resistive touch sensor, or other type of touch sensor. The upper layer 404 implementing the upper part of the touch sensor may be flexible such that it may bend, deform, or otherwise change shape when an object such as a stylus or finger is pressed against it in a downward direction. Therefore, layer 402 may deform or bend enough so that it may displace fluid in layer 404 and make contact with lower layer 406. Lower layer 406 may form a second half of a touch sensor layer and may be implemented with a material which is firmer than layer 404. Thus, lower layer 406 will not bend or be displaced when an object applies force to upper layer 402 and upper 402 makes contact with lower layer 406. In some implementations, lower layer 406 may be implemented with a hardened plastic, glass, or some other material.

The upper layer and lower layer surround middle layer 404 which can be implemented as a fluid, gel, or some other compressible material. The material layer 404 may extend throughout the volume created by layers 402 and 406, may be compressible, and may expand to fill out the volume defined by upper layers 402 and layer 406 when uncompressed. A stylus 410 may be used to apply input as a depression on the touch sensing layers 402 and 406. For example, when an object such as stylus 410 applies a force to the upper surface of their 402, layer 402 may be depressed into the space formerly occupied by layer 404 and the fluid that makes up layer 406 may be compressed into other portions of the middle layer. This may result in fluid (or gel or other material) having a lower volume and higher pressure within layer 404.

As shown in FIG. 5, when stylus 410 is pressed against the upper surface of upper layer 402, layer 402 may stretch and expand downward until it comes in close proximity or makes contact with layer 406. At the point where stylus 410 applies a downward force on the upper service the layer 402, .516, the fluid is forced away from that point in middle layer 404 and layer 402 stretches downward towards with layer 406. In an implementation, the touch sensor formed by layers 402 and 406 may detect the presence of a touch event as well as the location on the upper layer, for example point 516 in FIG. 5, at which the touch event occurs—in this case where stylus 410 applies a pressure to the upper surface of layer 402.

Pressure sensors 412 and 414 may detect the change in pressure between the point in time before the stylus is pressed down against the surface of layer 402 and a point in time while the stylus is pressed against the surface 402 to a point where layer 402 makes contact with layer 406. The change in pressure may be detected by several pressure sensors such as 412 and 414 around the periphery of layer 404. The set of pressure readings provided by the pressure sensors may provide the pressure as a function of time and magnitude to complement the capacitive touchscreen input. The pressure sensors may provide a finer level of detail regarding how hard the stylus is pressed down onto layer 502. In some instances, other pressure sensor types may be used, in place of or in addition to pressure sensors 412 and 414 which are generally located at the periphery of layer 404. The other pressure sensor types may be transparent and implemented at the surface of the middle layer or within the gel, fluid, elastomer, or other material that comprises the middle layer, and may be used to measure a change in pressure from within the middle layer, stretching of the middle layer for example using silver nano-wires, and other of pressure sensors.

In an implementation, middle layer 506 may be implemented as an elastomeric layer. As such, the degree of layer compression can be used as a means of determining how hard a stylus for 10 is pressed against a location on the surface of upper layer 402 in addition to the location itself. This provides a method for gathering data that is distinct from a method using embedded electrodes or transparent electrodes above the tactile layer in an elastomer layer. In the implementation illustrated in FIGS. 4 and 5, a change in pressure, even if electrically detected change in contour, can be determined by the underlined capacitive touchscreen, or by pressure waves exerted in the material that comprises middle layer 404. Additionally, the change in pressure may be detected using direct stressing of an embedded flexible transparent electrode structure.

The detected change in pressure may be due to a stylus. Different stylus types may be used with the interface described herein. A soft tip stylus may be used on to provide a pressure on the upper surface of the upper layer, the use of which is intended to mimic a user's finger. A relatively rigid tip stylus may be also be used, which is intended to mimic a writing utensil. When using any type of touch sensor, the pressure and therefore the magnitude of the touch cannot be determined—only the presence and location of the touch can be detected from the touch sensor. When a user's finger is providing an input, some touch sensors can estimate the pressure based on the foot print or “finger print” provided by the user input. If the finger print of the input on the touch surface includes a smaller area, the pressure of the finger is determined to be small. When a user presses a finger with more pressure on the upper surface of a touch sensor, the tip of the finger collapses and provides a larger area of contact on the upper surface of the touch sensor. Thus, some degree of pressure can be determined when a finger is used to provide input on a touch sensor, but the level or magnitude of pressure is difficult to determine, and will be inconsistent between different users due to finger size, pressures applied, and so forth. Utilizing a pressure sensor in addition to touch sensors as disclosed herein provides for several advantages over using a touch screen alone, including the ability to determine the magnitude of the input pressure in much more detail and with much better accuracy.

In addition to detecting inputs on a display screen, pressure sensors for a fluid layer may be used to detect the position of a slider. In an example, a finger may be moved up and down a slider that travels over a fluid or gel layer and is coupled with multiple pressure sensors. The multiple pressure sensors may detect pressure of different portions of the fluid layer that correspond to the position of the slider, as well as detecting the time of arrival of the pressure at the pressure sensor. By collecting this information, multiple pressure sensors can tell where the finger is along the slider.

A capacitance touchscreen layer may be useful in determining when a user touches a screen. However, a capacitance touchscreen layer may provide some amount of electromagnetic interference and/or effect a signal-to-noise ratio in the sensor output signal, which may affect the fidelity of a signal received from a display device from the touch sensor itself.

To mitigate these effects, other types of touch sensors may be used, such as for example a touch sensitive interface that utilizes a resistance sensor. FIG. 6 is a schematic representation of one variation of a touch-sensitive interface that utilizes a resistance sensor. The interface of FIG. 6 includes an upper touch sensor layer 602, a lower touch sensor layer 606, and a middle touch sensor layer 604. Upper layer 602 may be implemented with a flexible and pliable material that may give for stretch when input is received, such as for example by stylus 610. Upper layer 602 may include a thin, metallized foil layer on the bottom surface of layer 602. A voltage may be applied to one corner of the metallized foil layer, such that the voltage differs at different points in the metallized foil layer based on the resistance of the layer.

The middle layer 604 may include a gel, a fluid, or some other elastic material that may have a pressure that is measurable by pressure sensors 612 at 614, each of which along with other pressure sensors may be positioned along the periphery of layer 604. Upper layer 602 may be flexible while lower layer 606 may be a stable layer. Both layers may be coated with a thin electrically conductive coding, such as for example indium tin oxide or other material.

FIG. 7 illustrates a schematic representation of a touch sensor interface that receives an input from a stylus 610. When the upper layer 602 is depressed by a force, such as from stylus 610, the upper layer displaces fluid from middle layer 604 and eventually comes in contact with lower the layer 606. A unidirectional voltage may be applied to upper layer 602. When the upper layer 602 and lower layer 604 come into contact with each other, lower layer 606 measures the voltage as a distance along the first layer, which provides an x-coordinate for the resistance. When the contact coordinate has been acquired, the voltage gradient is applied to the second layer. Thus, the location of the contact point is determined as the resistance associated with the path travel by the voltage applied to the first layer and measured at the second layer. In this manner, the exact touch location associated with the contact can be determined with a high resolution and providing very accurate touch control.

When input is received to the upper layer of the resistive touchscreen that utilizes a fluid spacing layer between the two layers of a resistive touch sensor, the fluid is forced from the location of the input into the remaining volume of the middle layer 604. A series of pressure wave measurements are made by a series of discrete pressure sensors located along the border of layer 604. Thus, not only can the location of the input to be detected, but the force, velocity, and other information associated with the pressure events may be tech detected as well.

In some implementations, the resistive layer may only be used to determine a location upon detecting a pressure event through the pressure sensors. Hence, a voltage may not need to be applied to the resistive touchscreen layer unless a pressure event is detected at the one or more pressure sensors that monitor the pressure of the material comprising layer 604. By not applying a voltage to the resistive layer unless a pressure events is detected, less voltage may be applied to the resistive touchscreen layers over time than if the voltage was consistently applied, thereby reducing the power consumed by the resistive touchscreen.

The detection of a pressure-related event in the fluid layer can be characterized by an increase in fluid pressure within the variable volume that exceeds a threshold pressure. The pressure and a time associated with the pressure can detected by pressures sensors adjacent to the fluid layer 604 when the pressure is greater than the threshold pressure and a corresponding time of the pressure change event. Thus, the output of the resistive touch sensor may be determined at the corresponding time of the pressure as an input by triggering a voltage to be applied to the resistive touch sensor to search for the location of the input that mimic the change in pressure and occurs within a threshold time of the pressure-related event.

In particular, the pressure sensors can detect a pressure-related event corresponding to a force received at the surface of the upper layer 602 that forces layer 602 to make contact with layer 606 and records data output by a pressure sensor, such as a change in pressure of the volume at layer 604, an absolute pressure and/or a change in strain of the deformable region of depression of the deformable region, etc. Pressure sensors for layer 604 can continuously or intermittently sample for pressure, velocity, acceleration, strain, etc. If the pressure-related event yields a detected pressure greater than a predetermined threshold pressure, the system associated with the tactile interface can record the pressure-related event and the time of the pressure-related event. Pressure sensors for layer 104 can alternatively detect pressures within a range of threshold pressures (e.g., 1-2 atm). If pressure sensors 612 and 614 detect a pressure within the range of threshold pressures, the system associated with the interface of FIGS. 6-7 can record the pressure and a time the pressure occurred. Alternatively, pressures sensors 112 and 114 and the interface system can detect and record pressures outside the range of threshold pressures, as well as detect and record pressures below a minimum pressure.

We claim:

1. A method for registering user interaction with a dynamic tactile interface comprising a tactile layer and a substrate, the tactile layer defining a tactile surface, a deformable region, the deformable region cooperating with the substrate to form a variable volume filled with a mass of fluid, the method comprising:
detecting a first pressure related event of the mass of fluid at a remote pressure sensor fluidly coupled to the variable volume, the first pressure indicating that the pressure at the remote pressure sensor has increased;
in response to detecting the first pressure, detecting a touch by a touch sensor and providing an output by the touch sensor, the touch sensor associated with the deformable region;
identifying an intentional touch at the deformable region based on the detected first pressure of the mass of fluid and the output of the touch sensor
in response to the identified touch, executing by a processor a command corresponding to the touch at a processor.

2. The method of claim 1, wherein the pressure related event corresponds to depression of the deformable region from an expanded setting.

3. The method of claim 1, further comprising transforming the pressure-related event into a touch sensor input model associated with a time associated with the pressure sensitive event, wherein the intentional touch is based on a correlation between the touch sensor input model and the output of the touch sensor.

4. The method of claim 3, wherein the intentional touch is based on a correlation between the touch sensor input model and the output of the touch sensor within a threshold period of time.

5. The method of claim 1, wherein the first pressure related event corresponds to a pressure that exceeds a threshold associated with depression of the deformable region.

6. The method of claim 1, wherein the touch sensor sampling for touch input is initiated by the first pressure related event.

7. The method of claim 1, further comprising:
generating a touch sensor input model for a period of time corresponding to the pressure event and in response to the detected pressure event; and
comparing the touch sensor input model to a touch sensor output over a period of time associated with the pressure related event;

8. A method for registering user interaction with a dynamic tactile interface comprising a pressures sensor, a middle layer that is compressible, and a flexible touch sensor implementing an upper layer, the method comprising:
detecting a first pressure related event of the mass of fluid at the pressure sensor, the pressure sensor fluidly coupled to the middle compressible layer, the first pressure indicating that the middle layer volume has decreased;
detecting a change in a signal provided by the touch sensor, the change in signal indicating the occurrence of a touch event and the location on the upper layer of the touch event, the detection associated with an output of the touch sensor;
identifying an intentional touch on an upper surface of the upper layer of the touch sensor based on the detected first pressure related event and the touch sensor output
in response to the identified touch, executing by a processor a command corresponding to touch at a processor.

9. The method of claim 8, wherein change in signal is caused by a deformation of touch sensor.

10. The method of claim 8, wherein the touch sensor is a capacitive touch sensor.

11. The method of claim 8, wherein the touch sensor includes an upper layer and a lower layer, the upper layer positioned above the middle compressible layer and the lower layer positioned below the middle compressible layer, the change in signal created when the upper layer is deformed at a particular location on the upper surface of the upper layer through the middle layer and towards the lower layer.

12. The method of claim 11, wherein the deformation causes the upper layer to make contact with the lower layer.

13. The method of claim 12, wherein the touch sensor is a resistive touch sensor.

14. The method of claim 8, wherein the pressure sensor is located on the periphery of the middle compressible layer.

15. The method of claim 8, wherein the pressure sensor is located within the middle compressible layer.

16. The method of claim 8, wherein the first pressure event corresponds to depression of the upper layer by a stylus.

17. The method of claim 8, wherein the middle compressible layer is formed by a fluid, gel or an elastomer that extends between the upper layer and lower layer.

18. The method of claim 8, wherein the first pressures related event is associated with a time at which the event occurs and a location on the upper layer at which the first pressures related event occurs.

19. The method of claim 8, further comprising:
Generating a touch sensor input model for a period of time corresponding to the pressure event and in response to the detected pressure event; and
comparing the touch sensor input model to a touch sensor output over a period of time associated with the pressure related event;
